(19) United States
(12) Patent Application Publication
(10) Pub. No.: US 2016/0171590 A1
(43) Pub. Date: Jun. 16, 2016

(54) PUSH-BASED CATEGORY RECOMMENDATIONS

(71) Applicant: 0934781 B.C. Ltd, Vancouver (CA)

(72) Inventors: Kurt Robert KOLB, Burnaby (CA); Simon James HEWITT, Vancouver (CA); David Robert THOMPSON, Vancouver (CA); Ali DAVAR, Vancouver (CA)

(73) Assignee: 0934781 B.C. LTD, Vancouver (CA)

(21) Appl. No.: 14/936,298

(22) Filed: Nov. 9, 2015

Related U.S. Application Data
(63) Continuation-in-part of application No. 14/537,092, filed on Nov. 10, 2014.
(60) Provisional application No. 62/082,088, filed on Nov. 19, 2014.
(60) Provisional application No. 62/082,076, filed on Nov. 19, 2014.
(60) Provisional application No. 62/126,372, filed on Feb. 27, 2015.
(60) Provisional application No. 62/127,139, filed on Mar. 2, 2015.

(51) Int. Cl. G06Q 30/06

(52) U.S. Cl. CPC G06Q 30/0631

(57) ABSTRACT

A computer method and system comprising a database of business relationships between organizations, a computer processor and computer-readable instructions for retrieving data from the database and determining differences in B2B consumption patterns between a target organization and similar organizations. The system may communicate the differences, such as categories of product and services to a user associated with the target organization.

### RELATED APPLICATIONS

This application claims the benefit of: U.S. patent application Ser. No 14/537,092 filed Nov. 10, 2014, entitled “Recommendation Engine”; U.S. Patent Provisional Application Nos. 62/082,088 and 62/082,076, both filed on Nov. 19, 2014, both entitled “Business Relationship Accessing”; and Patent Provisional Application No U.S. Pat. No. 6,212,6372, entitled “Product or Service Recommendation”. The contents and disclosure of the above are incorporated herein by reference in its entirety.

### TECHNICAL FIELD

The present disclosure relates to methods for operating a system and database of business relationships between organizations. Certain methods are useful for determining what product and services are used by organizations to make a recommendation. The system may build a model of consumption. The system may comprise a computer network accessible via the Internet.

### BACKGROUND

Organizations supply and consume a variety of products and services from other organizations. This exchange may be at varying places in the supply chain and for different amounts. There is no simple way for an organization for the system to determine what products or services it is lacking, beyond determining its intrinsic needs. What's more is that an organization may not even be aware that certain product or services exist or that they are commonly consumed by other organizations.

The existing solution is for suppliers to advertise and educate potential customers about their own product and services, assuming they can identify the right potential customers. Even then, the customer needs unbiased evidence that the products are appropriate for themselves, the quality is right, and the amount of investment is appropriate given their own circumstances, rather than what the salesman suggests.

The present inventors have appreciated that whilst no two organizations will have identical consumption or supply of product and services, there may be an overall pattern which can be identified and reported to a target organization.

### BRIEF SUMMARY OF THE INVENTION

The inventors have envisaged a database, network, system, and methods for operating with data about business relationships. The inventors have appreciated that such a database may be used to identify consumption patterns of organizations, particularly those similar to a target organization. The patterns may be the basis for recommending products and services to the target organization.

In accordance with a first aspect of the present invention there is provided a computer-implemented method of communicating categories of product and services to a user associated with a target organization,. The method comprises: a processor determining, from a database of business relationships between organizations, organizations that are similar to a target organizations; a processor determining, from said database, a set of categories of product or services consumed by those similar organizations; and selecting and electronically communicating a subset of the categories to the user.

In accordance with a second aspect of the present invention there is provided a computer-implemented method of communicating categories of product and services to a user. The method comprises: (i) a processor determining, from a database of business relationships between organizations, a set of organizations that are similar to a target organization; (ii) a processor retrieving, from the database, attribute data of the similar organizations and their consumption data; (iii) a processor creating a model of consumption using said data in (ii); (iv) a processor determining consumption differences between consumption data of the target organization and a modeled consumption using the model input with attribute data of the target organization; and (v) communicating at least some of the consumption differences to the user.

In accordance with a third aspect of the present invention there is provided a computer system comprising: a database of business relationships between organizations; one or more computer processors; and computer-readable media having instructions for execution by the one or more processors. The instructions when executed communicate categories of product and services to a user by: retrieving, from the database, data objects of organizations that are similar to a target organizations; retrieving, from the database, data objects of products or services connected to the data objects of the similar organizations and determining, a set of categories of product or services consumed by those similar organizations; and selecting and electronically communicating a subset of the categories to the user.

The following features may be combined with the first, second and third aspects.

The processor may remove a second set of categories of product or services consumed by said target organizations from the set or subset of categories consumed by the similar organizations.

Determining the set of categories of product or services consumed by those similar organizations may comprise retrieving consumption data objects from the database, each consumption data object identifying the category of the product or service consumed and indicating one of the similar organizations as a consumer of the product or service.

The processor may score or rank the categories and select the subset depending on the score or rank.

The score or rank of a category may depends on one or more of a) the number of similar organization that consume that category; b) a similarity to the target organization of similar organizations that consume that category; c) the recency or frequency of past communications of categories with respect to the target organization; d) a trend factor calculated from a rate of change in consumption for that category; e) a calculated probability that the category is relevant to the target organization; or f) the relative proportion of similar organization that consume that category compared to the proportion of all organizations that consume that category.

The processor may determine an impact value of a plurality of template statistics for recommending a plurality of the categories and select and communicate some of the template statistics based on the impact value.

Communicating the subset of the categories may comprise serializing data about the categories in the format of at least one of: a notification on a smartphone app, an email, providing a web page about the target organization, or a targeted web ad to an employee of the target organization.

The processor may determine that the user is associated with the target organization.

The processor may retrieve data objects for organizations that are similar to the target organization greater than a threshold value of similarity.

The model of consumption may comprise a time-dependence and the processor may determine the modeled consumption for the target organization for a future date.

Determining consumption data of the target organization may comprise retrieving data objects representing the product or services consumed by the target organization.

The processor may calculate the statistical significance of consumption differences and select for communication those differences that are statistically significant.

The consumption differences may comprise categories of products and services.

The model may be one of: a functional relationship, a neural net, or a machine classifier.

Consumption data for the similar organization may be determined from data objects representing products and/or services, the data objects connected to the similar organizations' data object and indicating that the organizations consume the products and/or services

The consumption data may comprise a label of a category and attribute data about the relationship between a supplier organization and consumer organization.

### BRIEF DESCRIPTION OF THE DRAWINGS

The invention may be illustrated by the following figures, in which like reference numerals refer to similar elements.

FIG. 1 illustrates a diagram of a network of computers for accessing a database of business relationships.

FIG. 2 is a diagram of agents for interaction between a client device and server.

FIG. 3 is a diagram of database objects.

FIG. 4 is a diagram of a hierarchy of product/service categories.

FIG. 5 is a table of product/service consumption by groups of organizations.

FIG. 6 is a diagram of database objects connected to a target organization.

FIG. 7 is a flowchart for identifying and outputting categories.

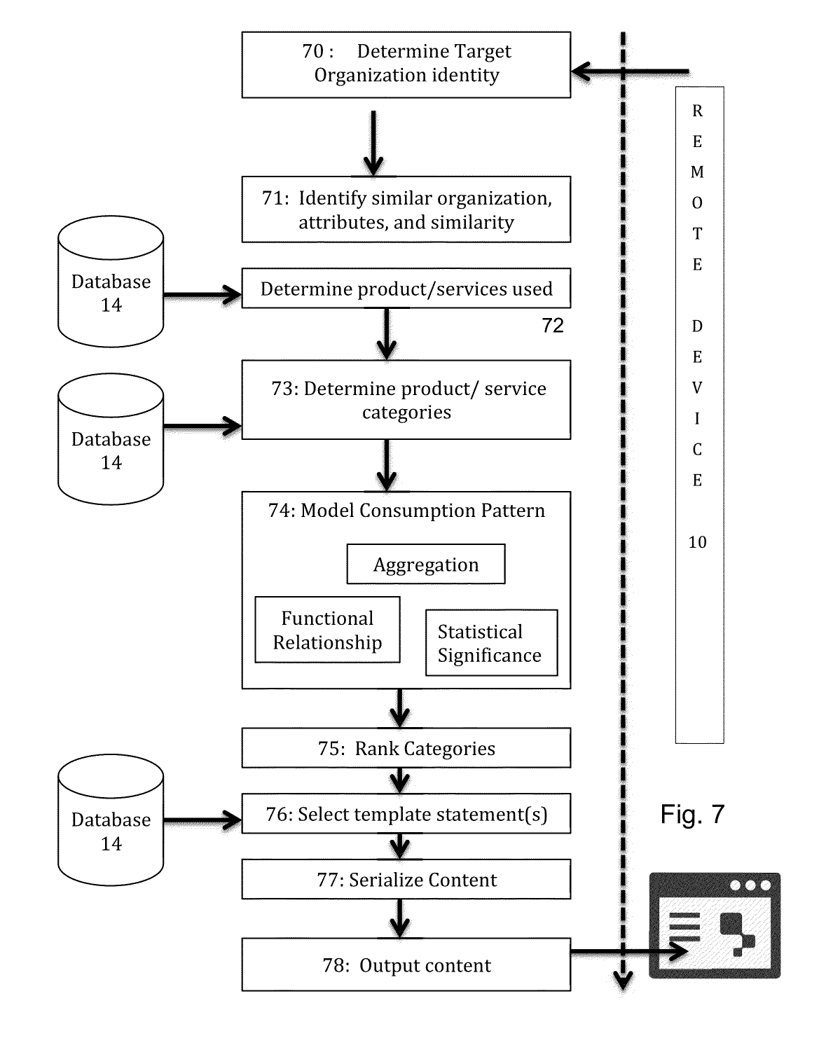

FIG. 8 is a webpage listing recommended categories for a target organization.

### DETAILED DESCRIPTION

A system, network, and computer program are implemented to capture the business relationships between organizations. This enables users, as viewers, to determine consumption of products and services. This also enables users, as content creators, to enter business relationship data which can be used to compute consumption for viewers to analyze.

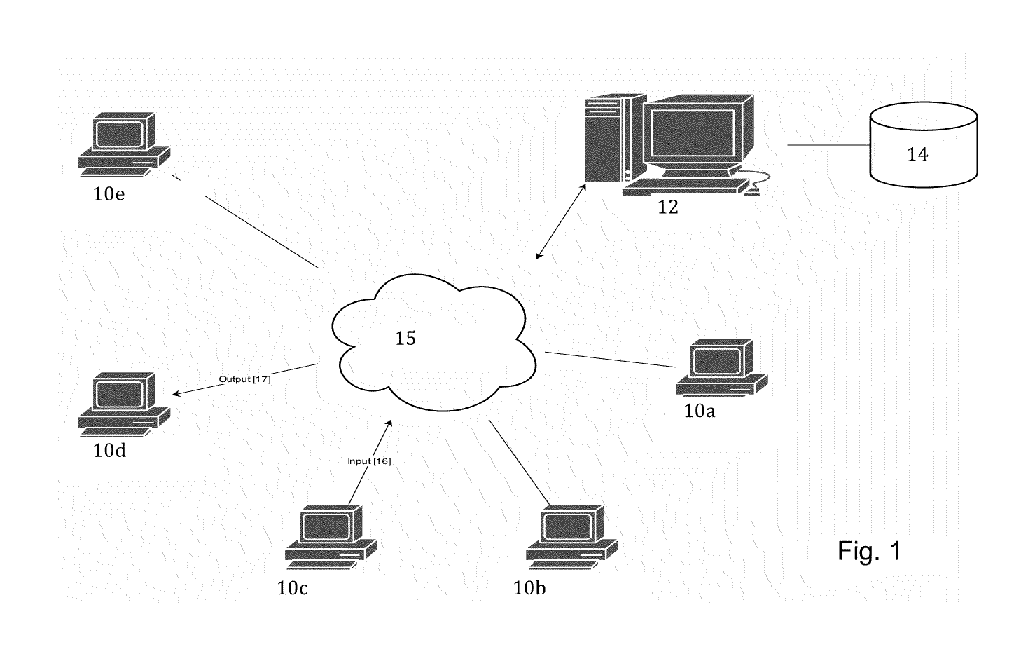

As shown in FIG. 1, the system may be implemented as a network 15 of interconnected computing devices 10a-e and server 12 for inputting and receiving relationship data from a database 14. The database may be a relational database, object database or graph database. Those skilled in the art of computer science will know how to implement such a database and will appreciate that there are other data structures that may be appropriate.

The server 12 may comprise one or more processors for reading instructions from computer-readable storage media and executing the instructions to provide the methods and agents described below. Examples of computer readable media are non-transitory and include disc-based media such as CD-ROMs and DVDs, magnetic media such as hard drives and other forms of magnetic disk storage, semiconductor based media such as flash media, random access memory, and read only memory.

An organization is generally used herein to refer to a legal entity providing or receiving products or services. While an organization may typically be a business, the term includes but is not limited to charities, corporations, sole proprietors, Non-Government Organizations (NGO), institutions, government departments, and partnerships. The term supplier is used herein to refer to organizations that supply products or services in a business relationship, notwithstanding that they may also consume products or services in another relationship. A business relationship is used herein to refer to a business-to-business (B2B) relationship or commercial transactions between organizations to provide those products or services. Preferably the relationship represents an agreement, which, for example, may subsist in a contract, a terms-of-business document or an ongoing understanding. Most preferably the business relationships stored in the database represent relationships that have been ongoing for at least three months or have at least three repeat instances of transactions. This is in contrast to personal relationships, non-commercial relationships, click-thru data or user website activity data, or one-off commercial transactions. Therefore the strength of the present recommendation is derived from a deep tie between organizations, as recorded in the database. An ongoing, high-value relationship is used as a proxy to suggest that the products or services are of high-importance to an organization.

A target organization as used herein is an organization for which a recommendation is being made or personalized search query results are being retrieved. In a given period, thousands of organizations may each be individually considered a target for which separate calculations are computed and personalized content generated. A target organization may be identified in real-time based on activities related to that organization and associated users. Alternatively the target may be selected by the computer, regardless of organization or user activity, such that content is generated, optionally stored for future use, and communicated to user(s).

A user is generally defined as a person who interacts with a computer, typically entering search criteria, following hyperlinks and viewing recommendations. A user is expected to be associated with, preferably employed by, a particular organization. In the case of recommendations, a user is associated with the target organization. In some cases, the database and methods will be accessed by a computer bot for displaying a relevant organization to a target organization or associated user. For example, an ad-tech bot may determine, using cookies or viewed content, that a user is working in a particular industry or for a particular target organization. The ad-tech bot could display ads to the user, depending on what products and services are most relevant to the target organization.

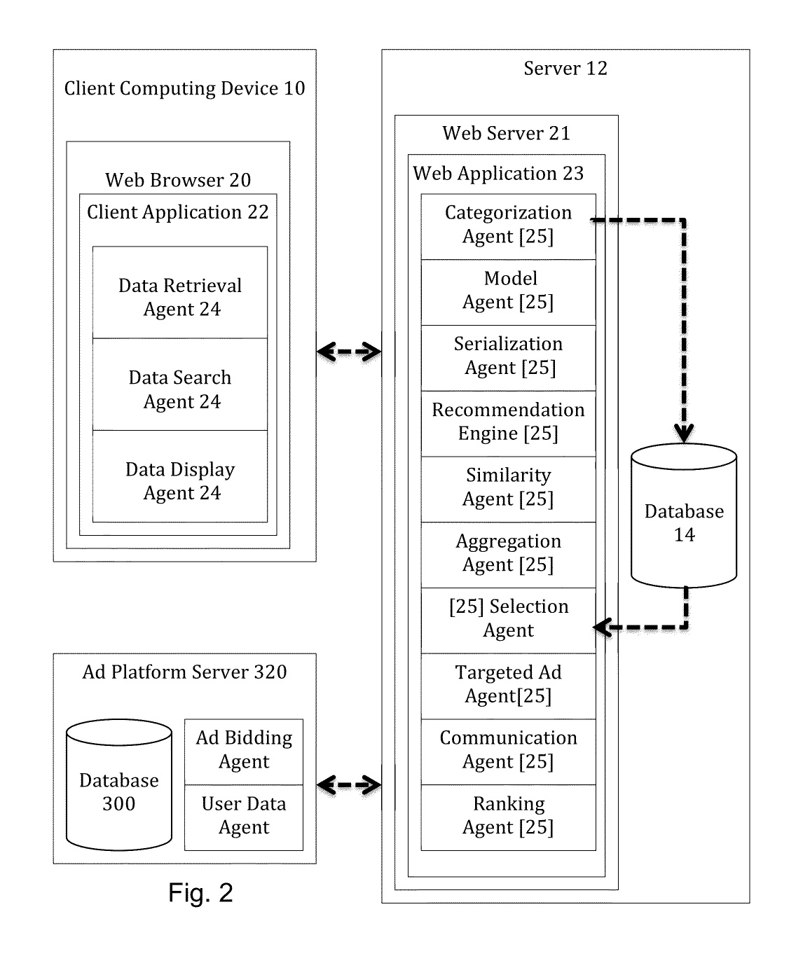

FIG. 2 illustrates the interaction between a client computation device 10 and the server 12 over network 15. The device 10 may interact via a web browser 20 having an application layer 22. The application may use software agents 24 to search the database 14, retrieve output data 17 and display the data on the user's device. The server 12 may be a reverse proxy server for an internal network, such that the client 10 communicates with an Nginx web server 21, which relays the client's request to associated server(s) and database(s) 14. Within the server(s) a web application 23 comprises agents 25 for operating with the database 14.

Users may access the database 14 remotely using a desktop or laptop computer, smartphone, tablet, or other client computing device 10 connectable to the server 12 by mobile internet, fixed wireless internet, WiFi, wide area network, broadband, telephone connection, cable modem, fibre optic network or other known and future communication technology.

The client device 10 may interact with the server using a web browser using conventional Internet protocols. The web server will use the serialization agent to convert the raw data into a format requested by the browser. Some or all of the methods for operating the database may reside on the server device. The client device 10 may have software loaded for running within the client operating system, which software is programmed to implement some of the methods. The software may be downloaded from a server associate with the provider of the database or from a third party server. Thus the implementation of the client device interface may take many forms known to those in the art. Alternatively the client device simply needs a web browser and the web server 12 may use the output data to create a formatted web page for display on the client device.

The methods and database discussed herein may be provided on a variety of computer system and are not inherently related to a particular computer apparatus, particular programming language, or particular database structure. In preferred embodiments the system is implemented on a server. The term ‘server’ as used herein refers to a system capable of storing data remotely from a user, processing data and providing access to a user across a network. The server may be a stand-alone computer, mainframe, a distributed network or part of a cloud-based server.

In contrast to other social networks storing mutual, non-directional connections (friend-friend, associate-associate, classmate-classmate), the present database and system are arranged to record the nature of relationships and their direction, for example, as indicated by the flow of products and services from a first organization to a second organization. For example the direction may be unidirectional in the case of buyer-seller or bidirectional in the case of a partnership. This enables the system to determine which organizations are supplies and which are consumers for a particular product or service.

The nature of the relationship may be described in general terms: vendor-client, provider-receiver, buyer-seller, supplier-customer; or in more specific terms: partners, client-advisor, manufacturer-assembler, designer-distributor-retailer, joint venture, client-service provider, investor-investee, parent-subsidiary. Alternative terms will occur to the skilled person as appropriate descriptions of a business relationship.

### Database Format

The database may be implemented in a variety of ways known within computing science, such as an object database, relational database or a graph database. Depending on the schema used the data about an organization may be called an object, a record or a node. Generally these may each be called a ‘data collection’ to capture the concept of a group of data elements associated with an organization, product/service or relationship without reference to a specific data schema. The skilled person will appreciate that descriptions herein of processing organizations, products/service, and relationships refer to the data objects representing them, rather than the organizations, products/services, and relationships themselves.

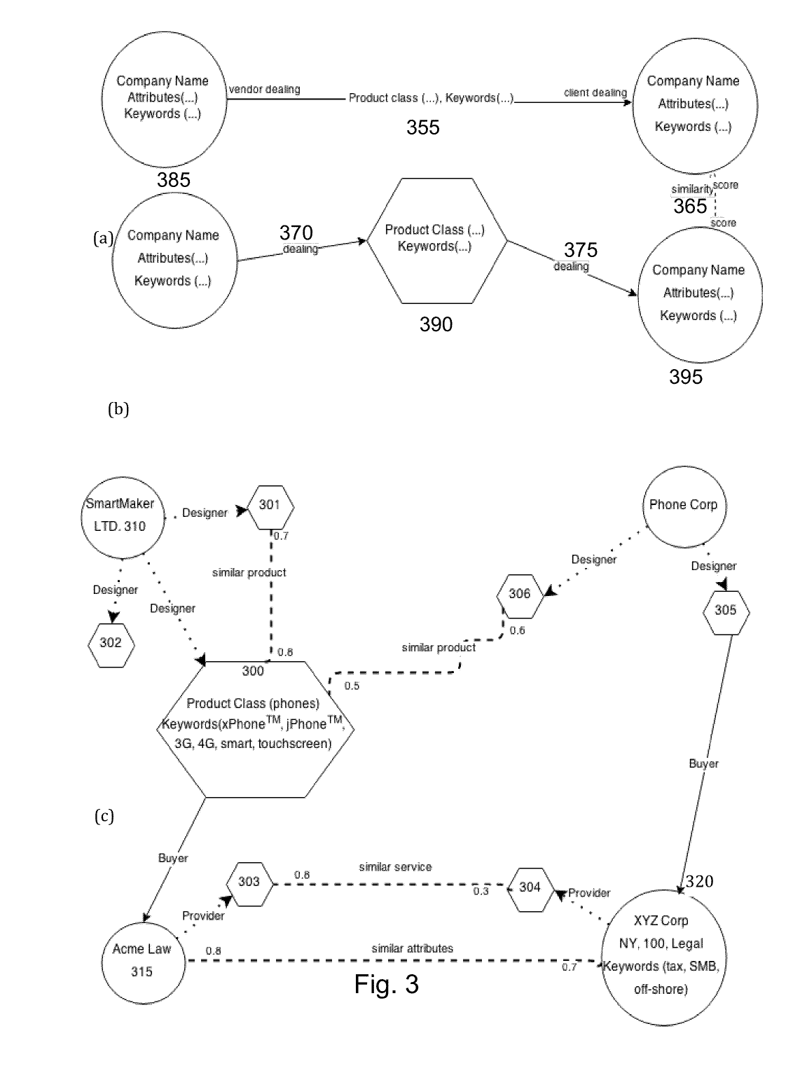

As conceptualized in FIG. 3 (b), the database is structured to record a plurality of business relationships 370, 375 (solid lines), data about the relationships (such as the nature of the relationship, reviews and monetary values), attributes about the organizations 385, 395 (circles), and products/services 390 (hexagons) supplied or consumed by organizations. The database may also record similarity 365 (dashed lines) between organizations. The direction is indicated graphically in FIG. 3 using arrows from the supplier 385 of products or services towards the consumer 395.

FIG. 3(a) illustrates an example database structure where a customer data object 365 is directly connected to supplier data object 385, and the data about the relationship (including the type of product or service) is recorded with the relationship data object 355. This is conceptually simpler than having a product data object 390 involved but requires replicating the product/service data for each relationship object.

The direction is indicated graphically in FIG. 3 using an arrow from the supplier of products or services to the receiver. There may be only one relationship recorded for an organization but in most cases there will be many. The database preferably comprises millions of organizations and relationships. The system may be operated as a social network or online community wherein numerous users input numerous relationships between numerous organizations.

In preferred embodiments, a graph database is used, wherein organizations are stored as nodes and business relationships are stored as edges. This is illustrated in FIGS. 3 by a solid arrow from a product hexagon to a consumer circle; by a dashed arrow from a supplier circle to a product hexagon; and a dotted line between similar organizations. An organization may be a supplier and a consumer, depending on the product or service in which they are dealing.

The graph comprises a first type of edge (relationship or dealing edge) between products and organizations defining how an organization deals with respect to a product; e.g. as a maker, assembler, buyer, etc. A dealing data object may include attribute data giving further details such as the time frames involved, investment amount, product type, sales amount, or terms of the contract. For example, “XYZ has sold reagents to NY Biotech Ltd since 2008, on a non-exclusive basis”. This attribute data provides the user with in-depth understanding of trends and significance of relationships.

The graph may comprise a second type of edge (similarity edge), which records the degree to which one organization is similar to another. The similarity edge may be bidirectional to indicate that two organizations are mutual peers or the edge may be unidirectional to indicate that one organization is considered similar to another organization but not vice versa, or at least not in the same way or degree. There may be more than one similarity edge between organizations to capture the different degrees or ways that two organizations are similarity. In FIG. 3(c), dashed lines are used to show where two organizations (315, 320) or two products/services (303, 304) are similar.

Alternatively, the database may be a relational database wherein a relationship/dealing record comprises foreign keys pointing to an organization and a product or service. An organization's attribute data may be stored in the organization's record, which is stored in the organization table.

A product or service supplied by an organization may be stored in a product/service table. A product record may include its product category, supply origin, brand name, model number and keywords. A company's service may be defined by its service category, office, specialism, and keywords.

Thus a complete relationship can be determined by collating data from relationship records, associated organizations records and associated product/service records.

The system stores data for organizations, products and services in the database and can find or compare organizations, product and services depending on the nature of the data. The data may be conceptually divided into different types:

Identification data that enable the system to identify the organization, product or service. Identification data includes data such as legal name, parent company name, brand name, office address, IP address, logos, trademarks, or company registration number;

Attribute data that describe properties of the organization, product and services using categories or values, but do not identify the organization. The attribute data may be sorted and classified according to a structure with defined terms. Attribute data includes classes and values such as industry, sector, general location, specialization, product category, service category, number of employees, market capitalization, field of practice, or revenue; and

Business segment data is a subset of attribute data for describing the business function or division of an organization and includes classes such as industry, sector, specialization, product category, service category, or field of practice.

### Similarity

The personalization of the recommendation is based on determining what organizations are similar to or peers of the target organization. It is possible that some peers to one organization are not peers to all other members of that peer group or they may have additional peers not in that peer group. An organization that provides two distinct services will have two sets of peers, whereby members of each set may not consider the other set to be in their own peer group. A similarity metric may be calculated between every organization in the database. This is computationally expensive and so this calculation is preferably processed offline and stored in the database. Preferably the processor only records similarity edges that are greater than a threshold similarity, so as to reduce the need to store data for minimally similar organizations.

In some cases, the target organization will not have been recorded in the database with similarity edges to any known peers. In this case, similar or peer organizations are determined in real-time for the recommendation.

A similarity edge may comprise a value measuring the degree of similarity or relevance. Alternatively, similarity edges may be recorded as either TRUE or FALSE. The similarity edge may comprise a text or code indicating the nature of the similarity (e.g. “small biotech peers”, “large banks”, “subsidiaries of XYZ Corp”). The nature of the similarity may be output to a user to indicate how organizations are similar.

In preferred embodiments, similarity between two organizations is calculated using multiple algorithms, which consider different factors such as similarity of attribute data and co-occurrence in online media. The similarity and co-occurrence may be with respect to the organizations themselves or the products/services they supply. The scores from these algorithms are weighted and combined to reach a similarity value.

For example, in FIG. 3 (c), organizations 315,320 are similar because they are both law firms, although the perceived similarity is not equal (0.8 vs. 0.7 out of 1.0). Moreover, they provide legal services 303,304, which are strongly similar (0.8) or weakly similar (0.3) depending on the perspective. Acme Law's service may be very similar to one of XYZ Corp's services, but there are additionally many more XYZ Corp services. The service and organization similarity values may be combined to find a weighted average similarity value of Acme Law to XYZ Corp.

As used herein, the terms ‘similar’ and ‘peers’ are related. Organizations may be considered similar because they have many attributes in common. Peers are similar with the added provision that they are in the same or related industry/sector/specialism and/or offer related products or services. Thus two organizations that have similar attribute data for size, location, and age are considered similar but may not be considered peers if they have different business segment data such as industry or sector. Two organizations in the same industry are considered peers, and comparing attribute data, such as revenue, location, and specialism, can further refine the similarity score. The skilled person will appreciate there are many known algorithms to calculate similarity metrics and/or perform peer clustering using attribute data. For example, similarity metrics could be based on Jaccard similarity coefficients or cosine distance, and peers could be clustered using expectation maximization, hierarchical clustering or density-based clustering algorithms.

Alternatively or additionally, similarity can be determined by co-occurrence in online journals, blogs and social media. This can be done by searching for the names of two organizations or their products/services in the same individual blog, microblog or industry journal article. Co-occurrence can also be found by noting the frequency with which people view both organizations in a web session. The co-occurrence approach is inherently less quantifiable but has the advantage of crowdsourcing to determine which organizations are actually perceived as peers or similar.

Similarity between organizations may also be inferred from an analysis of social networks and social media by determining which employees of organizations are connected. This assumes that people that share similar profession interests or know each other might work for similar organizations. This assumption is truer for social contacts within professional networks and industry-specific media, particularly when several employees of one organization are connected to several employees of another organization. The similarity agent employs bots to determine a connectedness score between organizations based on social inter-connectivity of their employees. The similarity agent may further determine the industries of the organizations. The agent assigns this connectedness score to similarity if the organizations are in similar industries.

### Product/Service Categories

Products and services may be described according to an infinite number of properties and keywords. In order to compare or aggregate similar products and services it is useful to be able to categorize them. Machine learning, may be used to divide many individual products/services into groups and then assign any new product /service to one of the groups. In some embodiments, the method's categorization agent uses supervised learning, such as neural nets and classifier algorithms, to assign one or more categories to each product or service.

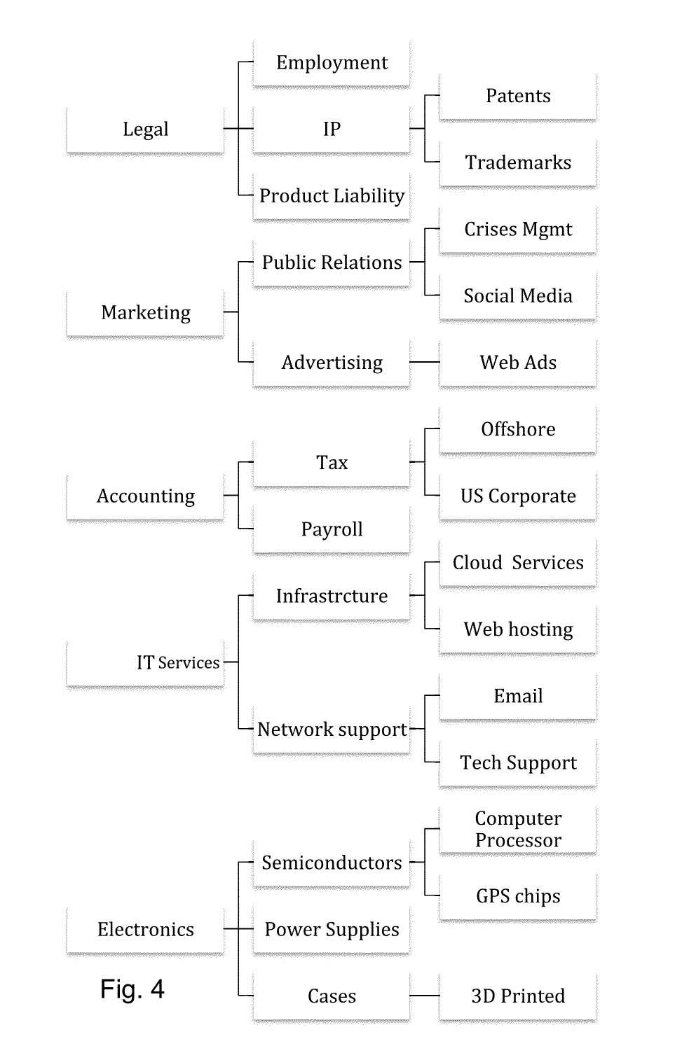

In another embodiment, the system implements a taxonomy of categories, such as shown in FIG. 4. Potentially thousands of categories and several levels are used to capture tens of thousands of product/service commodities. For example, the system could implement the The United Nations Standard Products and Services Code (UNSPSC) having a four-level hierarchy and eight-digit code to contain 50,000 commodities. Other standards such as NAICS, SIC-4, SIC-6, HS, European Union's Common Procurement Vocabulary, Germany's Eclass, and GS1′s Global Product Classification.

For either method the categorization is preferably done offline rather than in real-time. The category value (name or code) is stored with each product/service data object (or relationship object where the supplier and consumer are directly connected in the database).

Products/services may be compared or aggregated at the most specific or most general category level or by varying the confidence of the classifier.

### Recommendation Engine

The calculations and recommendation of categories of products and services may be instigated by a user wanting to identify deficiencies in his organization's business network. In some preferred embodiments, the motivation is to inform the user of deficiencies even when they are not actively looking. This is a push-based recommendation model. No search criteria are needed and the recommendations are based on the consumption patterns of a target organization's peers, possibly refined to match a user's web activity.

The recommendation engine may be conceptually divided into software agents or modules to process separate functions. A selection agent identifies from the database a set of organizations that are similar (hereafter ‘Similar Organizations’) to the target organization. A model agent determines a consumption pattern using the connections of Similar Organizations to product, service or organization data objects. The model uses the data about the product and services consumed to build a consumption pattern, which is intended to be easier for the user to digest and for the agent to make statements about the aggregated consumption, rather than list the thousands of products and services consumed individually.

A ranking agent selects, scores and ranks aspects of the consumption pattern for output to the user's computing device by the communication agent.

The selection agent uses the database of business relationships to identify relevant data object and retrieve certain data as required. The selection agent identifies similarity data objects (such as a similarity edge, see above) that have a code or foreign key for the target organization. For each similarity data objects where the similarity score, as viewed by the target organization, is above a similarity threshold, the agent identifies the other organization to create a set of Similar Organizations.

For each of the Similar Organizations, the selection agent identifies relationship data objects where the similar organizations are consumers and retrieves data about the product and services consumed. If a Similar Organization is connected directly to a supplier organization, the product/service data can be determined from the relationship data object or from attribute data of the supplier data object. For example, a supplier may supply only one service and the connected consumer is deemed to consume that service.

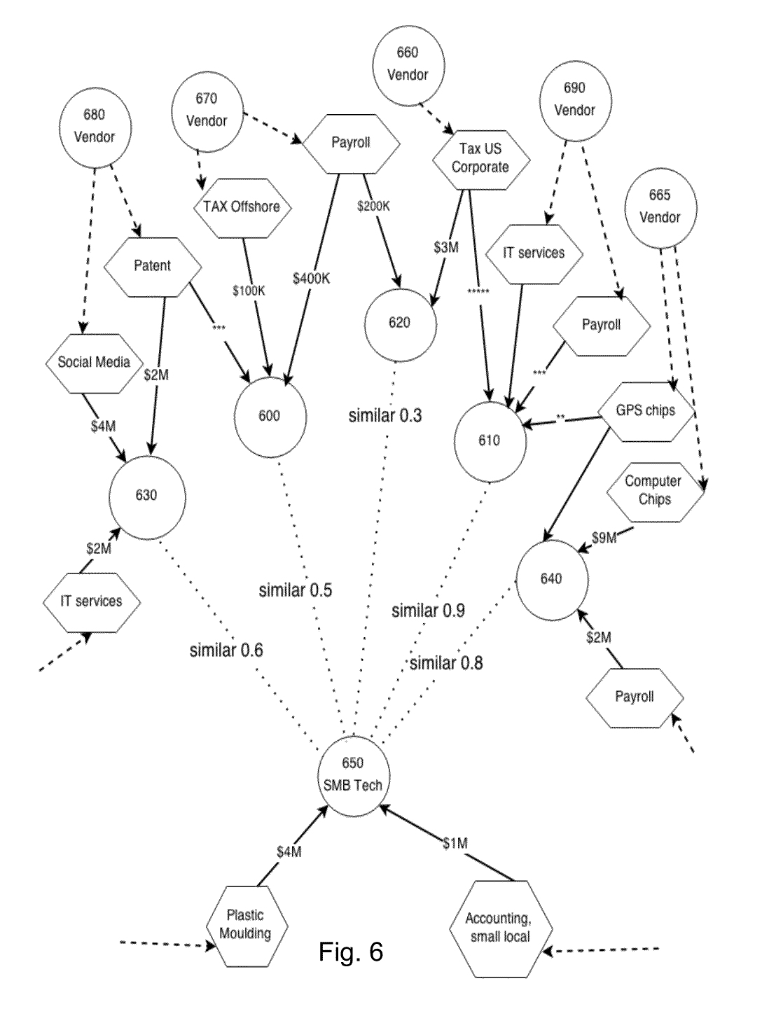

FIG. 6 illustrates a portion of a database, whereby target organization 650 is similar to Similar Organizations 600,610,620,630,640. The Similar Organizations consume eleven different products/services (hexagons) in fifteen instances (arrows) from vendors 660, 670, 665, 680, 690. The similarity values, spending amounts, or star ratings are recorded for certain edge objects. The attributes of the organizations and products/services are not shown here.

The types of data that are retrieved, when they are retrieved, and whether they are cached in local memory for processing will depend on the implementation coded by the skilled programmer. For example, the program may be implemented to identify a first Similar Organization, find that organization's first connected product, and retrieve the product category data for the model agent and then repeat for all organizations and their products. Alternatively the program may identify, retrieve and cache all Similar Organization objects, then cache all their consumed product objects, then send all data for the organizations and products to the model agent.

### Model

The model agent uses the product and service data to construct a model of consumption of the Similar Organization, which will be used to predict consumption for the target organization. As the data set may represent thousands of individual products/services, the model agent simplifies the data set into a consumption pattern by classifying, clustering, categorizing, building a neural net or formulating a functional relationship.

The model enables the user to view the database for at least two purposes: discovery and deficiency. Discovery allows the user to find new categories that they may have overlooked or never heard of. Highlighting deficiencies allows a user to see what part of their business may be sub-optimal or abnormal. For both cases this is done by building a model of consumption of peers and comparing that to the consumption of the target organization. The method communicates categories popular with a peer group or aspects of the consumption that do not match with the model's prediction.

In a basic embodiment, the model agent determines the category of each identified product/service, which is preferably tagged in the product/service data object. The agent then aggregates the data into a set of product/service categories and scores. This potentially reduces the product/service dataset to a dozen categories. The agent preferably records how many instances of each category were in the individual product/service dataset to score or rank the categories. The graph of FIG. 6 would reduce to: Payroll, 4; IT services, 2; patent 2, GPS Chips 2, etc.

In a refinement of the basic model, the agent scores or ranks the categories using the similarity values of the Similar Organizations and/or their spending on the category. These factors and others may be summed, weighted and combined to get a balanced scoring, or multiplied together to capture very similar organizations that also spend a lot or highly rate a category. Equations 1-4 below provide examples for calculating a score for a category.

CatScore1=n (1)

CatScore2=Σᵢ₌₁ⁿ similarityᵢ (2)

CatScore3=C1×Σᵢ₌₁ⁿ spendᵢ+C2×Σᵢ₌₁ⁿ ratingᵢ+C3×Σᵢ₌₁ⁿ similarityᵢ (3)

CatScore4=Σᵢ₌₁ⁿ similiarityᵢ×spendᵢ (4)

where CatScore is the score of a particular category; n is the number of Similar Organization that are consumers of that category; spend and rating are attributes of the relationship object indicating the amount spent on or rated for a category by each Similar Organization, similarity is the value of the similarity of a Similar Organization as viewed by the target organization, and C1,C2,C3 are weighting coefficients.

Returning to the example in FIG. 6, there are three objects that fit the “Payroll” category and four organizations connected to these, making this category highly relevant. There are other categories with multiple customers too. The category “computer chips” has only one customer but they are very similar (0.8) to the target and spend a lot of money ($9M) on the category. Thus depending on the equation used, the relative scoring of each category will change. Modifications of these equations will occur to the skilled person and the implementation will depend on the data available.

Additionally the model agent may store a set of global category factors that multiply the category scores from the Similar Organizations' consumption pattern. The global category factors may be chosen to reflect the commonness/nicheness or taxonomic specificity of the category. This prevents common, broad categories from always being recommended due to their numerous connections.

One method of determining a likelihood of a target company needing a product/service category is to create a predictive model of consumption based on attribute data. This provides an additional level of refinement in the recommendation beyond the binary observation that a peer consumes a product or not. A model enables the system to provide a more personalized recommendation based on organization attributes and the category attributes.

In one embodiment, a modeling agent retrieves attribute data of Similar Organizations, of the relationships with the suppliers, and of the products or services. The modeling agent may use techniques such as regression (linear, non-linear, or logistic), classifiers, and neural nets to discover a functional relationship between an organization and the products/services they consume. The skilled person will know techniques to program a computer to create the model.

Useful references include: Murphy, Kevin, Machine Learning: a probabilistic perspective. Cambridge, Mass.: The MIT Press, 2012. Print. and Bishop, Christopher M., Pattern Recognition and Machine Learning, Springer, 2006, Print.

Thus rather than simply knowing how many peers use a service, the system knows how an organization's size, location, age, and industry affect their likelihood of using the service. Moreover the system knows what attributes of the supplier or categories are preferable.

Once the model is created based on a target organization's Similar Organizations, the modeling agent retrieves the target organization's attribute data to predict the likelihood that the target would need a particular category. The agent also calculates attributes of the category and supplier that are most likely to be appropriate for the target. The agent repeats the model building and predictions for each identified category.

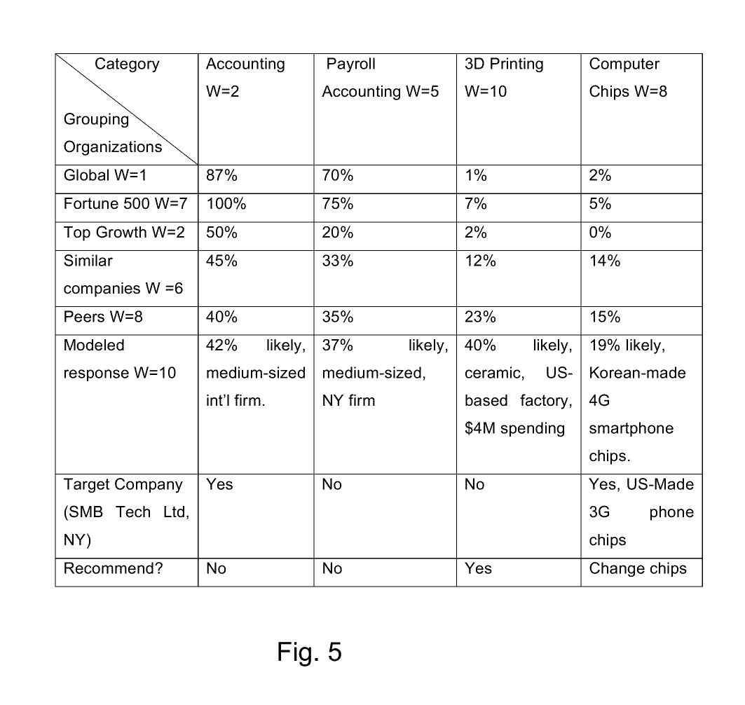

FIG. 5 is a sample table from a model for a target organization. Four categories (out of thousands) are compared using the consumption of five organization groups. The categories were selected to exemplify common and general (accounting), common and specific (payroll), trending (3D Printing) and lastly uncommon (computer chips) categories. The data represents the percent of organizations in a group that consume the relevant category of products or services. The modeled prediction, actual consumption and resulting recommendation are shown at the bottom. The weights W are shown after the category and grouping. The values, weightings W, categories, and groups are provided for example only and the real results will depend on the data in the database, the model algorithms, and implementation architecture. The following comments are made assuming a table exists with the data and model parameters shown.

Globally most organizations consume accounting services, which might make accounting a good category for recommendation. However, the category is too generic in the taxonomy to be a good personalized recommendation, which in this implementation gives it a low weighting. In the example taxonomy from FIG. 4, “payroll” is a subcategory within “accounting” and thus receives a higher weighting. Peer organizations have a 40% take-up rate of accounting services but this is lower than the global norm of 87%. The peers group has a high weighting (8) but the category has a low weight (2) which may be combined to make for a medium recommendation. The fact that the target organization already has a business relationship in the database for these services means they will not be recommended as a category.

The Table of FIG. 5 provides an example whereby the model created for a small-medium tech company in New York predicts that the company has a 42% likelihood of needing general accounting services and that the most suitable firms would be medium-sized with internationally presence. It makes similarly personalized predictions about the other services. The likelihood and supplier attributes were predicted from the model using the attributes of the target. The model agent predicts a 40% likelihood of needing “3D Printing”, which is much greater than the proportion in the peer group (23%). Possibly many of the target organization's attributes positively correlate with this service category, even though other attributes make it similar to organizations that do not use these services.

The system may also create an overall model of categories and organizations to determine a baseline to which the peer group model is compared. The model agent uses the baseline to determine categories that are uncommon or niche. A category weighting may vary inversely with its global commonness. Thus when a niche category (such as “Computer Chips” in FIG. 5) has even a few connections to a target's peer group, this appears as a large signal compared to the global norm, such that the niche category is highly scored or ranked.

In a preferred embodiment, the system considers the importance and statistical significance of category recommendations. Statistical significance is a measure of confidence that a statement or hypothesis is true, independent of the statement's importance. In this case, the null hypothesis is that catcgorics arc cqually rcicvant or that the consumption of a category for Similar Organizations is the same for organizations overall. The hypothesis is that the consumption of a particular category is higher for a peer group than globally. One calculation determines the confidence of that statement. A separate calculation would determine whether the statement was important enough to recommend the category.

For example, based on a large peer group, the system might determine that a target company's peer have statistically significantly more relationships with accountants than the global average, but that the difference is only 1% more so this fact is not deemed important. Conversely, the system might determine that a target's peer group spends twice as much on accountants as the global average, which sounds important, but the peer group's sample size is too small to make a statistically significant recommendation. Thus neither statistic would be useful to recommend these services.

In the simple situation of comparing peers and non-peers, where organizations either do or do not consume a category, the method may perform a binomial test to calculate a p-value which is compared to the significance level a. The significance level is a predetermined threshold for including or excluding categories to be recommended. As the harm of type I errors (i.e. making a recommendation) is low here, the system may choose a relatively high significance level such as α=0.20.

In some embodiments, a more complex analysis is used where the Similar Organization attribute values (e.g. similarity values, revenue, size) and/or the category attribute values are continuous variables. In this case, the method may use a multivariate Gaussian Process to calculate statistical significance. This analysis allows for considering a wider range of similar, but not quite peer organizations in the calculation and for predicting a range of values for the category, such as spending or supplier size.

Increasing the number of data points (i.e. peers that consume a category) increases the statistical significance, the degrees of freedom in the regression, and is required for some approximations. However some target's may have few close peers or peers consuming many different, specific categories. One way to compensate for a scarcity of data points is to widen the inclusion criteria for peers or a category. For example, the method may lower the similarity threshold or move up a level in the category hierarchy. There should then be more data points to make statements more statistically significant albeit for a more banal recommendation.

The system also determines, from the database, the product and services that the target organization already consumes, determines their categories and removes these categories from the set of the identified categories to recommend. The remaining categories represent that set of product/service categories that the target organization does not consume but maybe should. There may still be many categories to recommend and many ways to argue the need for each category.

The system thus comprises an algorithm to score, rank, and/or select categories that are likely to be important to the user and present a rationale for the score, rank or selection.

### Conditional Probability

A balance can be drawn between recommending niche, perhaps obscure categories and common ones the user already knows by using conditional probability. This provides an estimate of the probability of a target needing a particular category by computing the association of a category with a peer group, whilst compensating for the overall commonness of a category.

$$CatScore 5 = \frac{( X AND Y )}{X} / \frac{( ! X AND Y )}{! X}$$

where X is the number of peers, Y is the condition “uses this category”, !X is the number of organizations that are not peers. For large datasets, the score could be simplified as,

Catscore5′=Proportion _peers/Proportion-globally

where Proportion_peers is the proportion of peers that use this category and Proportion_overall is the proportion of organizations in the whole database (or a representative general population) that use this category. Thus looking at FIG. 5, “accounting” is a commonly consumed category (87%) but is less common in the peer group (40%) yielding a category score of 0.46. Conversely, the category “Computer Chips” scores higher at 15/2=7.50.

The system may also determine and suggest categories based on overall norms in the database. This is useful to identify mainstream categories that are consumed by most organizations. The system calculates, for each category in the database, the percent of organizations that consume this product or service. Overall norms are based on all organizations in the database or may be refined by region, size or attribute value as discussed above to provide convincing statistics that a category is normal or desirable generally or within a relevant group of organizations. For example, the system may determine the percent of all organizations or percent of Fortune 500 companies that receive accounting services.

The categories are scored or ranked to determine the overall top categories which are communicated to the user, preferably as a separate block of category recommendations. This highlights to the user which categories are normal for most organizations to use without attaching any significance to his industry peers or trends. The overall category norms are preferably calculated periodically and stored in a database.

### Trends

The system may also monitor for trends in product/service categories and use the trend data to more highly weight categories for recommendation that are positively trending. A trend agent may examine the connections in the business relationship database for trends in time and trends in similarity to the target. In the time dimension, the trend agent determines the change in a category's consumption over a given time. This rate may include the number of relationships and/or value of the relationships for a given period of time (the year and month), and preferably not the time at which the data was added to the database, although the latter may be used if the data does not indicate when the products/services were being consumed.

In a similarity dimension, the trend agent may also determine a trend with respect to a category's increasing/decreasing prevalence amongst organizations progressively similar to the target organization. A simplistic formula would be the a) proportion of peers using a category divided by the b) global proportion using that category, such that values above one indicate a trend of that category towards a target's peers and thus the target itself. A more refined algorithm would be a logistic regression using each organization's similarity to the target (continuous variable) and whether or not they use the category (Boolean). The majority of organizations can be considered to have a similarity value of zero and a category usage equal to the global average. The regression produces not only a better estimate of the trend by using more data but also a measure of the statistical significance of the trend, which can be used to ignore weakly-supported trends.

The trend agent increases the score for recommending the category by either setting a high category weighting or multiplying a category's score by a trend factor. In FIG. 5, “3D Printing” is highly weighted (W=10) because the category is found to be niche and positively trending in time. There is also a trend for organizations progressively closer to the target (1%->12%->23%) to use “3D Printing.”

In a preferred embodiment, the effects of trends in time are captured by including a time-dependence in the model. In B2B decision-making, the selection of a category or a specific supplier may take several months. Moreover the decision should reflect an organizations needs for the subsequent months or years. The system thus uses a predetermined or user-selected time-offset (for example one year). The model agent then predicts the consumption pattern for the target organization using the present data plus the time-offset. This will more highly score categories that are increasing in popularity.

Trend analysis enables the system to recommend nascent categories where there may be very little data to support a recommendation compared to established categories with many relationship objects.

### Comparing Business Networks

In one embodiment, the system uses the model to recommend improvements to a target organization's existing relationships and consumption pattern. The model may use the attributes of Similar Organizations and products/services to determine a ‘normal’ consumption pattern. The system may determine categories where the target company is underrepresented or not using the best products/services or not following trends. For example, the system may identify that, compared to its peers, the target company is spending only one half the normal amount on advertising, has relationships with the wrong financial institutes for its size, and has not upgraded to the fastest computing services now available.

The consumption pattern is compared to the target organization's relationship objects to determine differences, preferably determining the importance of those differences and removing statistically insignificant differences. The target organization is thus able to optimize its network and supply chain using these modeled differences

In FIG. 5, “Computer Chips” are already consumed by the target organization. However, in comparing the attributes of the actual and predicted consumption, the model agent detects and outputs several differences such as factory locations and type of chips in re-recommending the category “Computer Chips.”

### Providing Rationale

The method may also generate statements or rationale for recommending a category using the computed importance and statistical significance. The method may compare importance and significance to thresholds and remove statistically insignificant and unimportant statements.

In addition to the simple statistic of the total number of Similar Organizations that have a particular matching category, the Similar Organizations and their relationships may be presented in an almost limitless number of ways that are all logically true. For example, the system could display the number of Similar Organizations that use a category with a random attribute, or the category that is common to a random subset of the peers. Neither of these arbitrary facts is convincing to the user. In order to provide a more convincing suggestion, combinations of organization attributes and category attributes are used to create a set of template statistics.

For example, peers may be grouped as: Fortune 500 companies, European government agencies, high-growth companies (with an algorithm to determine growth and a thresholds for inclusion), closest peers (with a definition for determining closeness), competitors, charities, or companies in the target's industry. The category taxonomy may be used to group products at different levels (product class, super-class, sub-class). Relationship data may be grouped by ranges for attributes such as revenue (grater than $1M) or duration (greater than one year). A template statistic may be compiled from these divisions of companies, relationships and categories.

The Similar Organizations and their product/service categories are selected and aggregated to fit the set of template statistics. Each template statistic has a relative impact weighting which is multiplied against the number of matches to determine an impact score of the statistic. The skilled person will appreciate that the weighting or algorithm should more highly score statistics that are uncommon in the database and/or commercially relevant. Fortune 500 companies are uncommon and also relevant because of their financial success. The companies in the target's industry may be common, but very relevant.

The template statistics are ranked or compared to a threshold score to determine which statistics to display to the user. The ranking or scoring of categories is not necessarily the same as the ranking or scoring of statistics for display. The system determines the top categories to recommend and separately determines the best rationale for explaining the recommendation.

For example, the system may determine that in the target's peer group there are “ten Fortune 500 companies that receive cloud services”; “30 New York companies that receive remote IT services”; and “two competitors that hire industrial espionage services”. Compared to the second statistic, the first statistic shows fewer companies but the template statistic weightings are much higher to score it higher overall. The third template weighting is very high because of its niche category and relevant companies but there are not enough companies for the product category to be considered a trend. In this case, the service category pushed to the user is ‘Cloud Services” and optionally the reason shown is that ‘ten Fortune 500 companies in your peer group use this category.”

### Displaying Data

A subset of categories is communicated to the user to advise them of general categories of products and services that their organization appears to have overlooked. The communication may be an email, notification in a smartphone app, targeted web ads, or made visible on the organization's homepage on a website maintained by the present system. For ease of digestion, the categories may be communicated one at a time to the user. The target organization's homepage is a good place to communicate a large number of these selected categories, such that the user has an overview of the deficiencies. The website user interface (UI) provides means for the user to organize, select, ignore, or investigate the categories.

These communications provide data about the categories such as a description of the category, companies similar to the target organization that buy the relevant product and services, and examples of suppliers. The communications provide links for each category for the user to find personalized recommendations of suppliers for that category.

Although the categories may be scored and ranked, the top categories are not always the one communicated to the user, as one purpose of the method is to advise the user of categories they may not be aware of. After the first communication of a category, there is some expectation that the user knows they do not have a supplier in that particular category so they do not need constant reminding. There may be a reason for this absence. Thus the system communicates the higher ranking/scoring categories first or more frequently but will eventually communicate middle ranking categories.

There is also an expectation that the user is familiar with common categories, such as accounting and legal advice. The system is arranged to favor communicating to the user, categories that are relevant to a peer group but not common or known. The most common categories can be identified from the proportion of overall organizations using the category as discussed above. The common categories can be communicated in a separate portion of the recommendation and removed from the personalized recommendation portion.

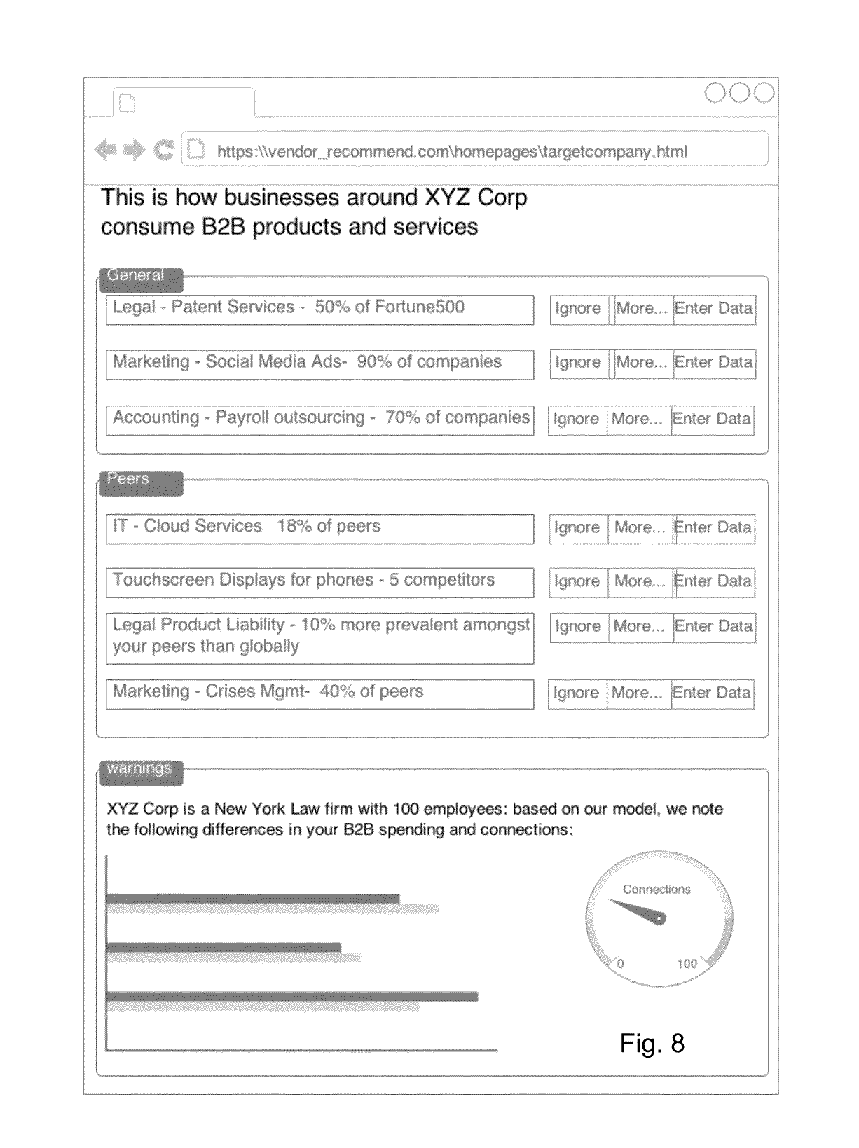

FIG. 8 is an example website showing category recommendations for a target organization. The website separates categories that are generally popular from those popular amongst peers. The website also shows warning where the target consumes categories in a way significantly different from the peers. A bar chart compares spending in three categories by the target and peers. For each category, there is a statistic explaining why the category is relevant to the target organization. Three interactive elements after each category allow the user to a) ignore the category such that it will not be shown again, b) request more information and receive supplier recommendations for that a chosen category, and c) enter data about the target's relationship(s) with respect to a chosen category. There are potentially other categories consumed by their peers which are not displayable on this page but are accessible via link to “other categories” or will be shown the next time the page is displayed.

The method selects a subset of the identified categories to be communicated to the user. The selection of the subset depends on the rank, score, recency and/or frequency of previous communications of categories for the target.

The data related to the categories, statistics, and/or Similar Organization are used to form the web content. The communication agent serializes the web content in a format readable by the user's web browser and communicates said web content, over a network, to the client-computing device of the user.

What is claimed is:

1. A method of communicating categories of product and services to a user associated with a target organization, the method comprising:
a processor determining, from a database of business relationships between organizations, organizations that are similar to the target organizations;
a processor determining, from said database, a set of categories of products or services consumed by those similar organizations; and
a processor selecting and electronically communicating a subset of the categories to the user.

2. The method of claim 1, further comprising removing a second set of categories of product or services consumed by said target organizations from the set or subset of categories communicated to the user.

3. The method of claim 1, wherein determining the set of categories of product or services consumed by those similar organizations comprises retrieving consumption data objects from the database, each consumption data object identifying a category of a product or service consumed and indicating one of the similar organizations as a consumer of the product or service.

4. The method of claim 1, further comprising scoring or ranking the categories and selecting the subset depending on the score or rank.

5. The method of claim 4, wherein the score or rank of a category depends on the number of similar organization that consume that category.

6. The method of claim 4, wherein the score or rank of a category depends on a similarity to the target organization of similar organizations that consume that category.

7. The method of claim 1, wherein the selection of the subset of categories to communicate depends on the recency or frequency of past communications of categories with respect to the target organization.

8. The method of claim 4, wherein the score or rank of a category depends on a trend factor calculated from a rate of change in consumption for that category.

9. The method of claim 4, wherein the score or rank of a category depends on a calculated probability that the category is relevant to the target organization.

10. The method of claim 4, wherein the score or rank of a category depends on the relative proportion of similar organization that consume that category compared to the proportion of all organizations that consume that category

11. The method of claim 1, further comprising determining impact values for a plurality of template statistics for recommending a plurality of the categories and selecting and communicating some of the template statistics based on the impact value.

12. The method of claim 1, wherein communicating the subset of the categories comprises serializing data about the categories to provide at least one of: a notification on a smartphone app, an email, a web page about the target organization, or a targeted web ad to an employee of the target organization.

13. The method of claim 1, further comprising determining that the user is associated with the target organization.

14. A method of communicating categories of product and services to a user, the method comprising:
(i) a processor determining, from a database of business relationships between organizations, a set of organizations that are similar to a target organization;
(ii) a processor retrieving, from the database, attribute data of the similar organizations and their consumption data;
(iii) a processor creating a model of consumption using said data in (ii);
(iv) a processor determining consumption differences between consumption data of the target organization and a modeled consumption using the model input with attribute data of the target organization; and
(v) communicating at least some of the consumption differences to the user.

15. The method of claim 14, wherein the processor retrieves data objects for organizations that are similar to the target organization with greater than a threshold value of similarity.

16. The method of claim 14, wherein the model of consumption comprises a time-dependence and the processor determines the modeled consumption for the target organization for a future date.

17. The method of claim 14, wherein determining consumption data of the target organization comprises retrieving data objects representing the product or services consumed by the target organization.

18. The method of claim 14, further comprising calculating statistical significance of consumption differences and selecting for communication those differences that are statistically significant.

19. The method of claim 14, wherein the consumption differences comprise categories of products and services.

20. The method of claim 14, wherein the model is one of: a functional relationship, a neural net, or a machine classifier.

21. The method of claim 14, wherein consumption data for the similar organization is determined from data objects representing products and/or services, the data objects connected to the similar organizations’ data object and indicating that the organizations consume the products and/or services

22. The method of claim 14, wherein the consumption data comprises a label of a category and attribute data about the relationship between a supplier organization and consumer organization.

23. A computer system comprising: a database of business relationships between organizations; one or more computer processors; and computer-readable media having instructions for execution by the one or more processors, which instructions when executed communicate categories of product and services to a user associated with the target organization, by:
retrieving, from the database, data objects of organizations that are similar to the target organizations;
retrieving, from the database, data objects of products or services connected to the data objects of the similar organizations and determining, a set of categories of product or services consumed by those similar organizations; and
selecting and electronically communicating a subset of the categories to the user.
